(19) United States
(12) Patent Application Publication
(10) Pub. No.: US 2010/0299600 A1
(43) Pub. Date: Nov. 25, 2010

(54) ELECTRONIC COOKBOOK

(76) Inventors: Bobby C. ARCHER, Lakewood, NJ (US); R. Susan ARCHER, Lakewood, NJ (US)

Correspondence Address: Diane Dunn McKay, Esq.;PORZIO, BROMBERG & NEWMAN, P.C., Suite 201, 29 Thanet Road, Princeton, NJ, 08540, US

(21) Appl. No.: 12/469,233

(22) Filed: May 20, 2009

(51) Int. Cl. G06F 3/048; G06F 17/28; G10L 15/26; G10L 13/00

(52) U.S. Cl. 715/716; 361/679.21; 361/679.05; 715/810; 704/3; 704/235; 704/260

(57) ABSTRACT

The present invention relates to an electronic cookbook that can be mounted in a kitchen environment. The electronic cookbook includes means for indexing one or more types of electronic recipes on a display using a data processor and displaying the indexed types of electronic recipes on the display. Indexed electronic recipes can be selected and a list, such as in alphabetical order, can be displayed. One or more of the indexed electronic recipes can be selected and interactively displayed. The electronic cookbook can be set up for a particular language and/or measurement unit. The electronic recipes can be stored at the data processor. The electronic cookbook can include a speech recognition device for translating speech spoken into a microphone into text. The electronic cookbook can also include a USB port for receiving a USB insertable memory stick including stored electronic recipes.

### BACKGROUND OF THE INVENTION

1. Field of the Invention

The present invention relates to an electronic cookbook providing easy access to the cookbook in a kitchen environment and providing an interactive display for indexing, accessing and interactively displaying recipes.

2. Description of Related Art

Electronic books are known. U.S. Pat. Nos. D425,558 and D517,545 disclose designs for electronic books. The books do not include a stand and would be used as a handheld book.

U.S. Pat. No. 5,495,557 to Hyman et al. describe an electronic book which enunciates words or phrases corresponding to sentence parts and a complete sentence. The words and phrases are arranged in particular categories and by depressing various buttons an audio sentence is produced.

U.S. Pat. Nos. 6,405,167 and 7,110,945 describe an interactive book including a display to display various words on pages of a book. A microphone is provided to pick up the displayed words a child reads. An electronic speech recognition device communicates with the microphone for recognizing the spoken word. A highlighting device highlights one of the words on the display when the word was properly annunciated.

The above described electronic books appear to be for displaying words during handheld use or flat placement on a surface. It is desirable to provide an electronic cookbook including a stand or mounting device allowing easy access to the book in a kitchen environment and to provide an interactive display for indexing, accessing and interactively displaying recipes.

### SUMMARY OF THE INVENTION

The present invention relates to an electronic cookbook that can be mounted in a kitchen environment. The electronic cookbook includes means for indexing one or more types of electronic recipes on a display using a data processor and displaying the indexed types of electronic recipes on the display. Indexed electronic recipes can be selected and a list, such as in alphabetical order, can be displayed. One or more of the indexed electronic recipes can be selected and interactively displayed. The electronic cookbook can be set up for a particular language and/or measurement unit. The electronic recipes can be stored at the data processor.

The electronic cookbook can be mounted with a cabinet door hanger slidably extendable from a top of a housing of the cookbook which can be received over a cabinet door. In one embodiment, telescopic hanger rods are used for the mounting of the electronic cookbook and freeing up counter space in the kitchen. Alternatively, a pivotable stand can be located on the rear of the electronic cookbook for supporting the electronic cookbook on a kitchen countertop.

Selected indexed electronic recipes can be displayed in a longest to shortest preparation time format. The electronic cookbook can be interactively displayed by reading each step of a recipe out loud. A next step icon can be selected for interactively displaying a next step of the electronic recipe. A previous step icon can be selected for interactively displaying a previous step of the recipe.

The invention will be more fully described by reference to the following drawings.

### BRIEF DESCRIPTION OF THE DRAWINGS

FIG. 1 is a front view schematic diagram of an electronic cookbook including a cabinet door hanger in an extended position in accordance with the teachings of the present invention.

FIG. 2 is a side view schematic diagram of the electronic cookbook including the cabinet door hanger in an extended position.

FIG. 3 is a top plan view of the housing of the electronic cookbook including channels for receipt of hanger rods of the cabinet door hanger.

FIG. 4 is cut away view of the channel in a housing of the electronic cookbook and movement of the hanger rods within the channel.

FIG. 5 is a side view schematic diagram of the electronic cookbook in an embodiment including an extendable stand.

FIG. 6 is a rear view schematic diagram of the electronic cookbook.

FIG. 7 is a schematic diagram of the housing of the electronic cookbook including components positioned within the housing.

FIG. 8 is a schematic diagram of an embodiment of a set up screen for the electronic cookbook.

FIG. 9 is a flow diagram during a set-up operation of the electronic cookbook.

FIG. 10 is a schematic diagram of an embodiment of main index screen of the electronic cookbook.

FIG. 11 is a flow diagram during a recipe indexing and accessing operation of the electronic cookbook.

FIG. 12 is a schematic diagram of an embodiment an index display screen of the electronic cookbook.

FIG. 13 is a schematic diagram of a recipe display screen of the electronic cookbook.

FIG. 14 is a flow diagram during a recipe an interactive displaying operation.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

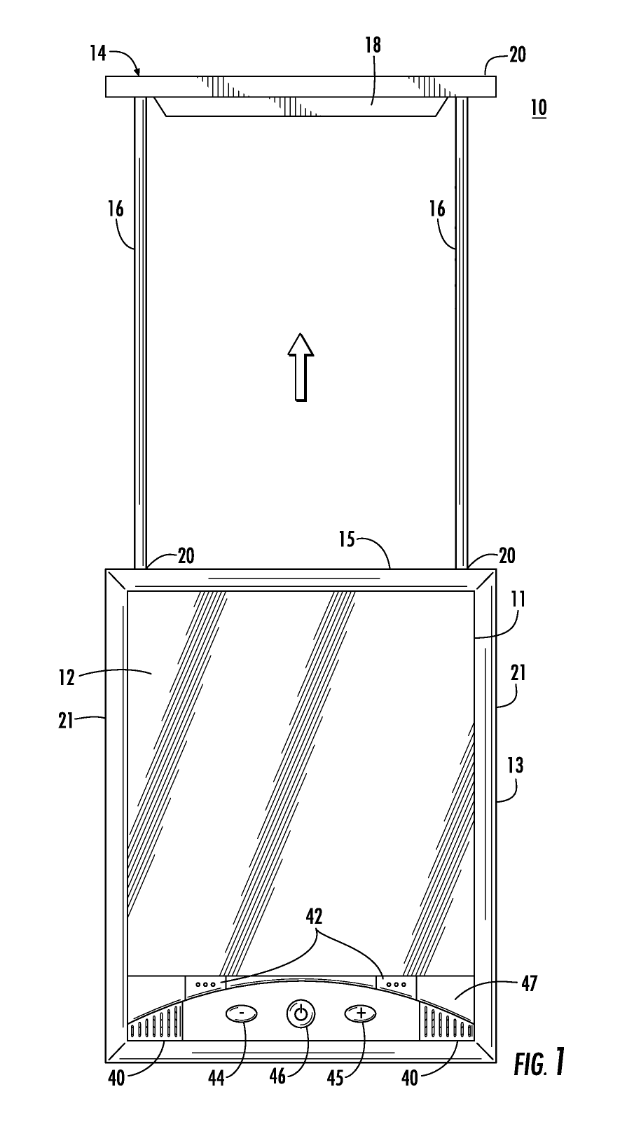

FIG. 1 is a front view of electronic cookbook 10 in accordance with the teachings of the present invention. Display screen 12 is housed within housing 13 at front surface 11. For example, display screen 12 can be a liquid crystal display (LCD) type screen and can be a touch-screen. Cabinet door hanger 14 is slidably extendable from top 15 of housing 13. Cabinet door hanger 14 includes hanger rods 16 coupled to cabinet door hook 18.

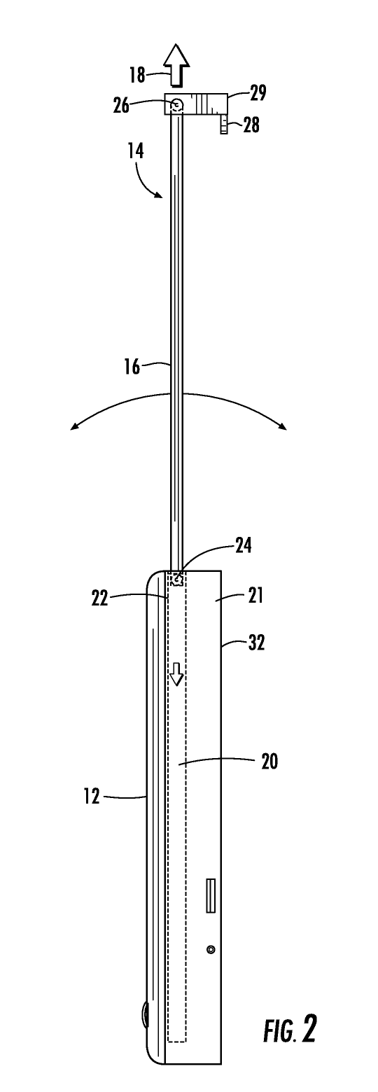

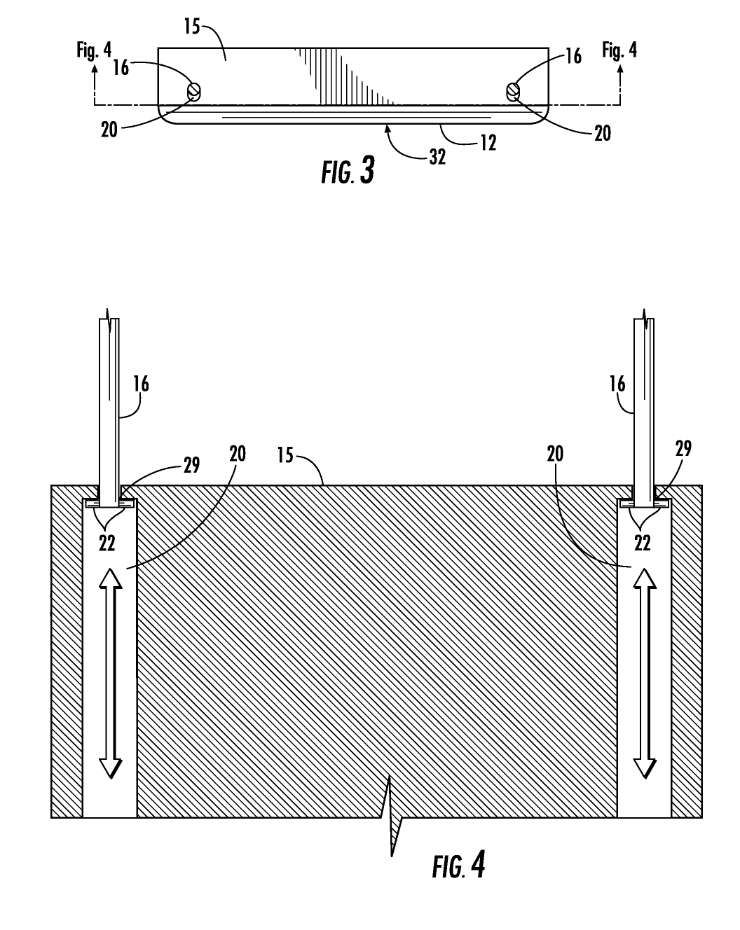

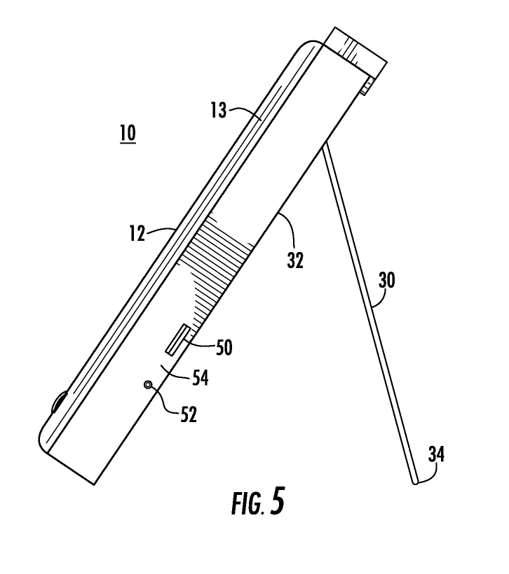

Hanger rods 16 are movable within channel 20 formed in side 21 of housing 13, as shown in FIG. 2-4. Hanger rods 16 can be telescopic, as shown in FIG. 2 in which the length of hanger rods 16 can be adjusted. Hanger rods 16 can be telescopically extended to a predetermined distance to allow display screen 12 to be at or near eye level of a user of electronic cookbook 12. Rollers 22 can be attached to hanger rods 16 with pin 24 for providing slight lateral movement of hanger rods 16 within channel 20. Rollers 22 also provide vertical movement of hanger rods 16 within channel 20.

Cabinet door hook 18 can be pivotally mounted to hanger rod 16 with pin 26 for providing slight upward movement of cabinet door hook 18. Cabinet door hook 18 includes protrusion 28 at end 29. Protrusion 28 of cabinet door hook 18 can be received over a kitchen cabinet door (not shown) for attaching cabinet door hanger 14 to the kitchen cabinet door.

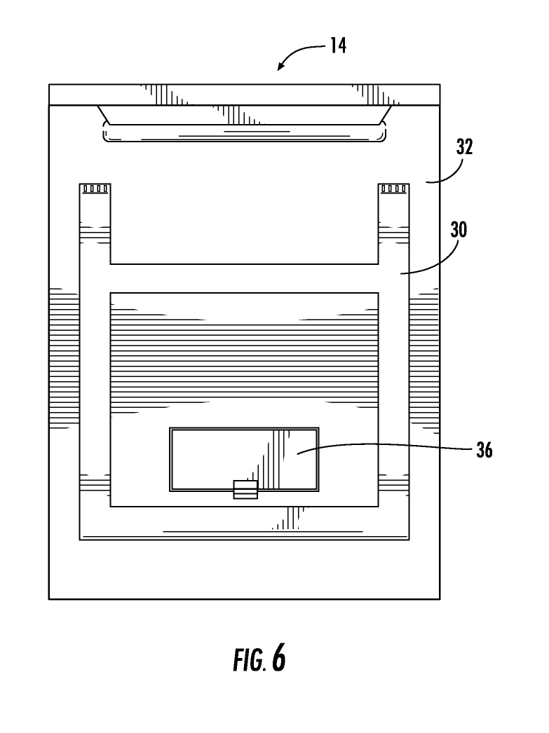

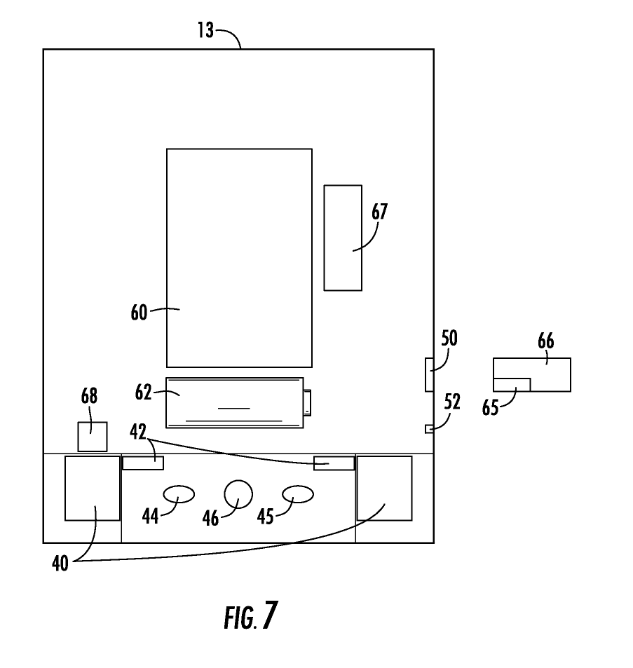

In one embodiment, electronic cookbook 10 can include stand 30 extendable from rear surface 32 of housing 13, as shown in FIG. 5 and FIG. 6. Stand 30 can be pivotally mounted to rear surface 32. Stand 30 can be extended and foot 34 of stand 30 can be supported on a kitchen counter (not shown).

Battery door 36 can be formed in rear surface 32 of housing 13, as shown in FIG. 6. Battery door 36 can be opened for access to a power supply such as a battery (not shown).

Referring to FIG. 1, one or more speakers 40 can be formed within or coupled to housing 13. Microphone 42 can be formed within or coupled to housing 13. Volume down button 44, volume up button 45 and power button 46 can be formed within or coupled to housing 13. For example, speakers 40, microphone 42, volume down button 44, volume up button 45 and power button 46 can be formed in lower edge 47 of housing 13. USB port 50 and power cord port 52 can be formed in side surface 54 of housing 13, as shown in FIG. 5.

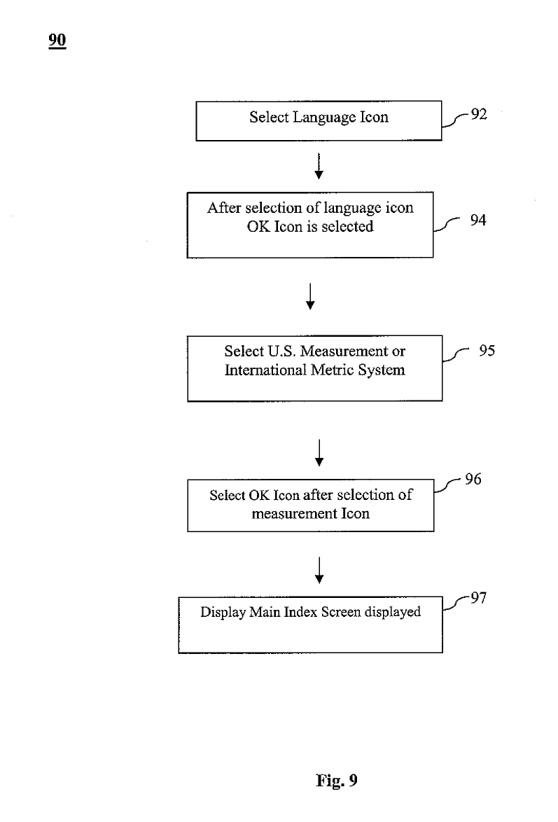

Processor 60 can be housed within housing 13, as shown in FIG. 7. Processor 60 performs processing functions for indexing, accessing and displaying information on display screen 12, as described below in the operations shown in the flow charts of FIGS. 9, 11 and 14 and others described herein. Processor 60 can be, for example, a CPU general purpose processor or integrated circuit which under normal operation processes data under the control of an operating system and application software stored in Random Access Memory and/or Read Only Memory. The operating system can provide a graphical user interface (GUI) to the user. Power source 62 is provided for providing power to the electronics of the present invention. For example, power source 62 can be a removable battery positioned within battery door 36. Power source 62 can be engaged by pressing of power button 46. Power can also be supplied by a power cord (not shown) inserted in power cord port 52. Volume down button 44 and volume up button 45 control the volume of speakers 40. Speech Recognition Device 68 can translate speech spoken into microphone 42 into text.

Cookbook 65 can include a cookbook in digital format. Cookbook 65 can be stored, for example, on a USB plug insertable memory stick 66 that includes proprietary compatible coding to function when inserted into USB port 50 of electronic cookbook 10. Memory 67 can store cookbook 65 uploaded from memory stick 66 at processor 60. One or more cookbooks 65 can be uploaded and stored in memory 67. Each of cookbooks 65 can relate to a separate cooking topic, such as, for example, Italian Cooking, French Cuisine, Southern Cooking, Grilling and Barbeque, and the like, or from a known particular chef.

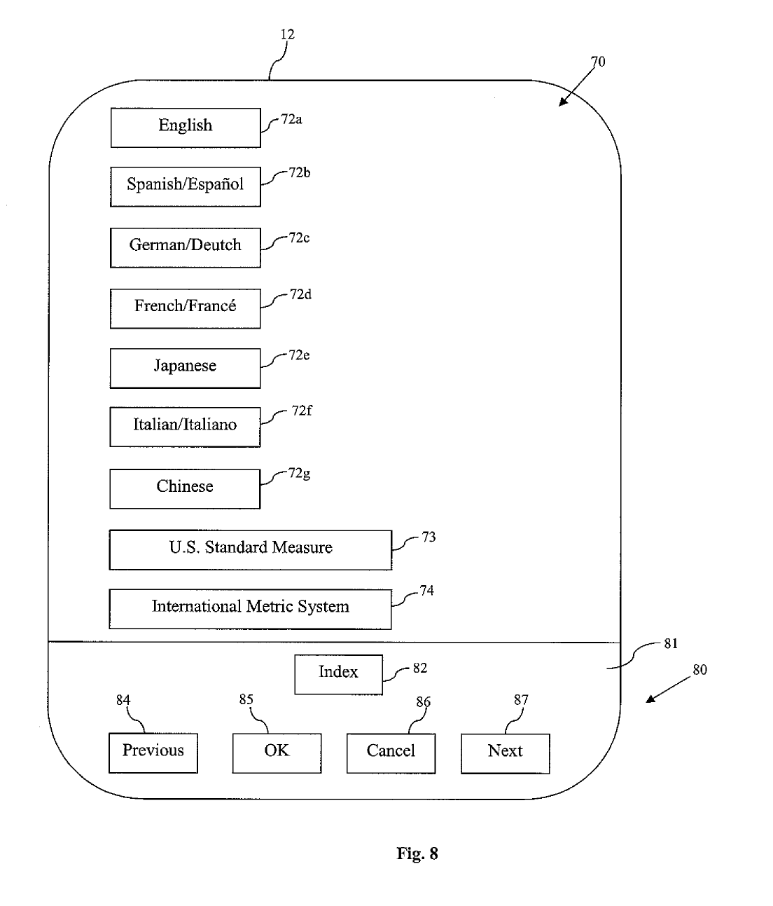

FIG. 8 is a schematic diagram of set up screen 70 which can be displayed on display screen 12. Set up screen 70 includes English language icon 72a, Spanish language icon 72b, German language icon 72c, French language icon 72d, Japanese language icon 72e, Italian language icon 72f and Chinese language icon 72g which can be selected for displaying different languages. U.S. standard measure icon 73 can be selected for displaying measurement values in U.S. standard measurements. International metric measure icon 74 can be selected for displaying measurement values in the International metric system.

Interaction icon portion 80 is positioned at lower portion 81 of display screen 12. Interaction icon portion 80 can be constantly displayed on display screen. It will be appreciated that interaction icon portion 80 could be positioned at various locations of display screen 12, for example at the upper or side portions of display screen 12 (not shown). Index icon 82 can be selected for displaying an index of types of recipes. Previous icon 84 can be selected for movement to a previously selected screen. OK icon 85 can be selected for making a selection on display screen 12. Cancel icon 86 can be selected for canceling a selection on display screen 12. Next icon 87 can be selected for movement to a next screen selection on display screen 12.

FIG. 9 is a flow diagram during set-up operation 90. In block 92, one of language icons 72a-72g can be selected. After one of language icons 72a-72g is selected electronic cookbook 10 operates all input and output of text and speech in the selected language. If no languages are selected with icons 72a-72g, the language selected will be defaulted as English. In block 94, after selection of one of language icons 72a-72g, OK icon 85 can be selected to save the language selection. In block 95, one of U.S. standard measurement icon 73 or International measurement icon 74 can be selected. After one of U.S. standard measurement icon 73 or International measurement icon 74 is selected OK icon 85 can be selected in block 96. Thereafter, electronic cookbook 10 displays all input and output of text and speech in the selected standard of measurement. In block 97, after blocks 91-96 are performed the set up operation is complete, a main index screen 100 is displayed on display screen 12.

During powering on of electronic cookbook 10, set up screen 70 can be displayed. If no changes are to be made in set up screen 70, Index icon 82 can be selected for displaying main index screen 100.

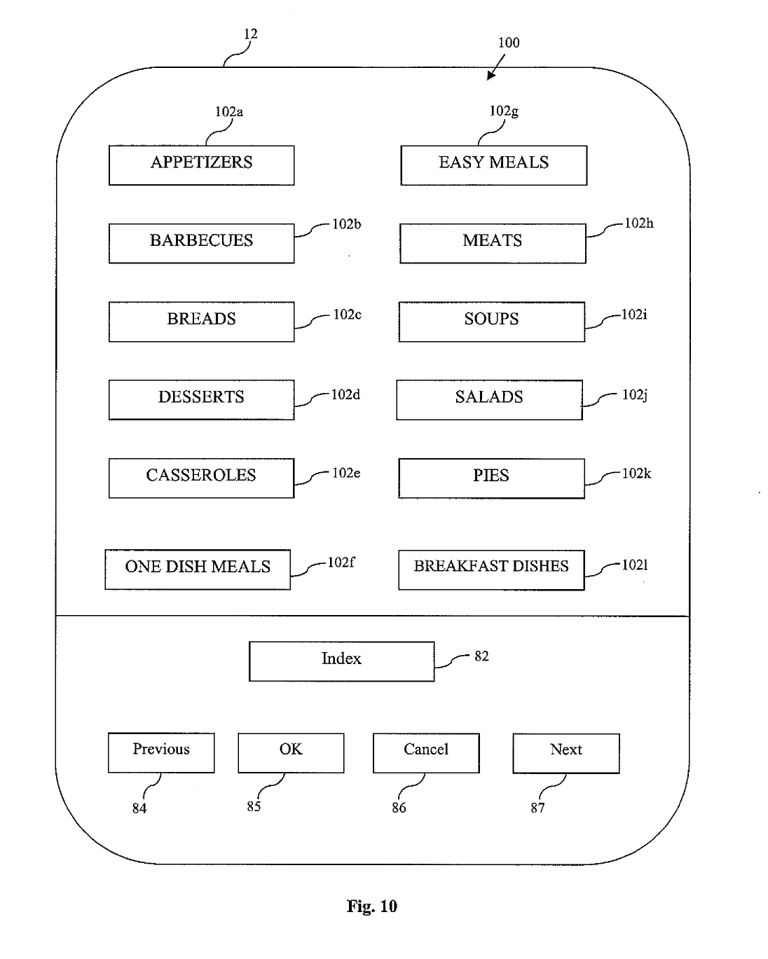

FIG. 10 is a schematic diagram of an embodiment of main index screen 100. Main index screen 100 includes a plurality of food category icons, such as, for example, including appetizers icon 102a, barbeques icon 102b, breads icon 102c, desserts icon 102d, casseroles icon 102e, one dish meals icon 102f, easy meals icon 102g, meats icon 102h, soups icon 102i, salads icon 102j, pies icon 102k and breakfast dishes icon 102l. It will be appreciated that other icons directed to various food categories could be used and displayed in main index screen 100 in accordance with the teachings of the present invention.

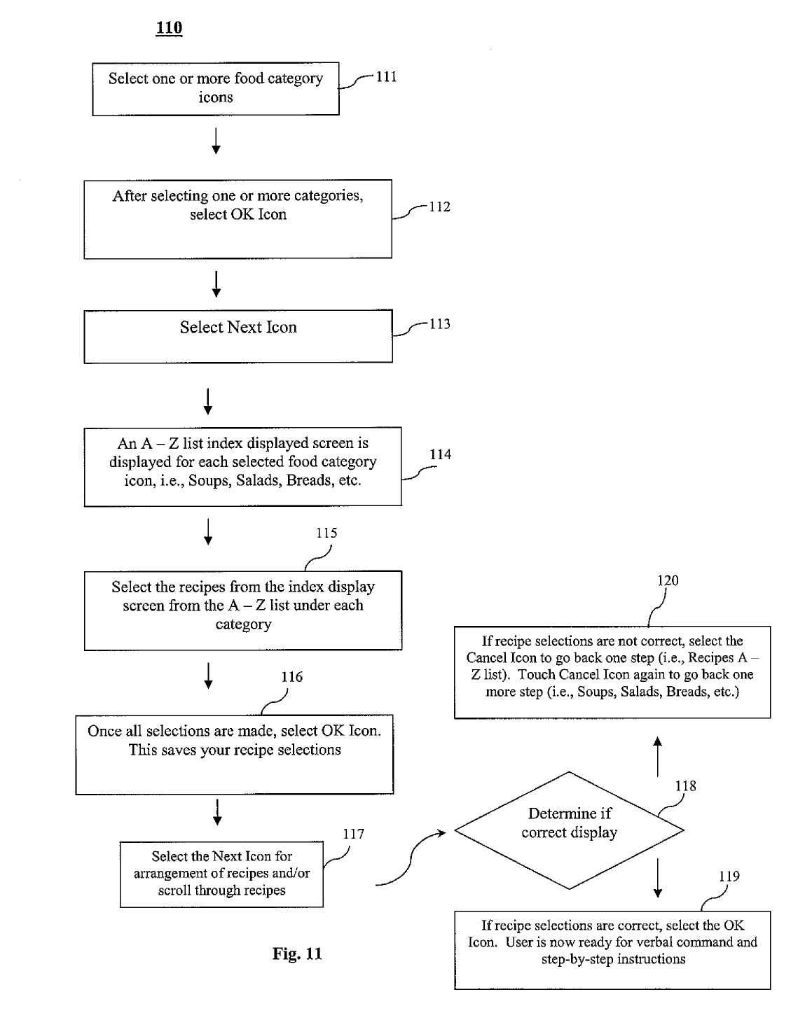

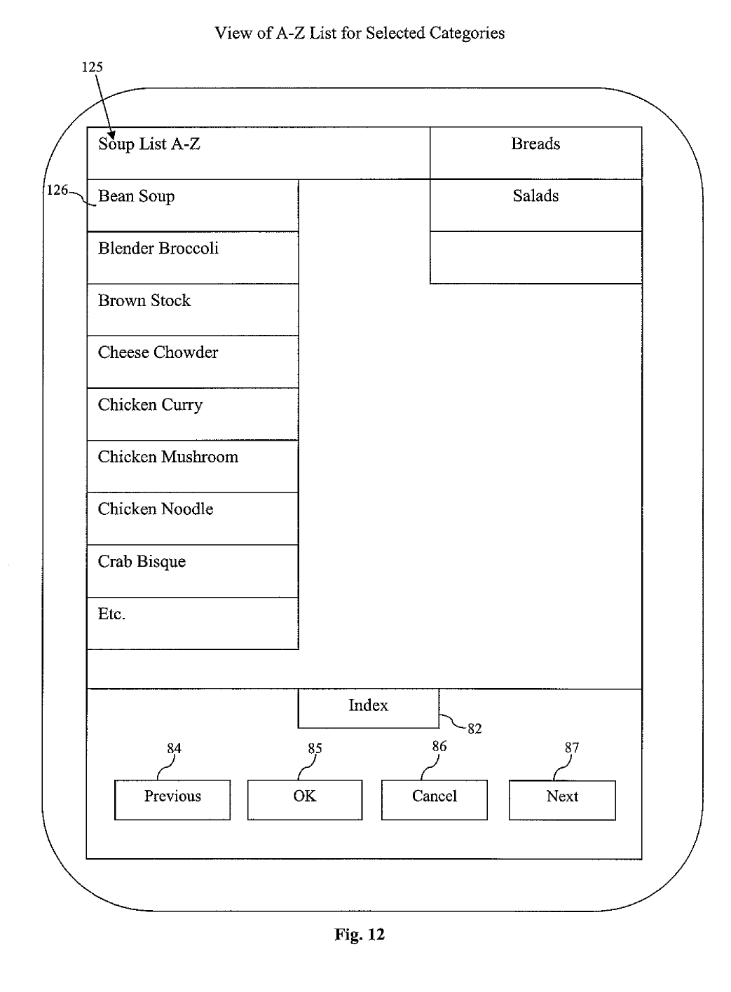

FIG. 11 is a flow diagram during a recipe indexing and accessing operation 110. In block 111, one or more of food category icons 102a-102l can be selected. In block 112, after selection of food category icons 102a-102l, OK icon 85 can be selected to save the food category selection. In block 113, Next icon 87 is selected. Upon selection of Next icon 87, an alphabetical index is displayed for each selected food category icon as an index display screen in block 114. An example index display screen 125 is shown in FIG. 12. Alphabetical index 126 is displayed for the selected food category icon, in this example, an alphabetical index 126 is displayed for the selected food category of soups.

Referring to FIG. 11, one or more recipes are selected from index display screen 125, in block 115. In block 116, after all recipes are selected, OK icon 85 is selected for saving the recipe selections for the selected food category. In block 117, Next icon 87 is selected to arrange recipe selections. In one embodiment, recipe selections are arranged into a longest to shortest preparation time format. Alternatively, Next icon 87 can be used to scroll through selections and Previous icon 84 can be used to scroll back through the selections. In block 118, a determination is made if the recipe selections are correct. If the recipe selections are correct, OK icon 85 can be selected in block 119 and recipe screen 125 is displayed. In block 120, if the recipe selections are not correct, Cancel icon 86 can be selected once to go back one step to the displaying index display screen 125 or Cancel icon 86 can be selected twice to go back two steps to display of the food categories in main index screen 100 and different selections can be selected.

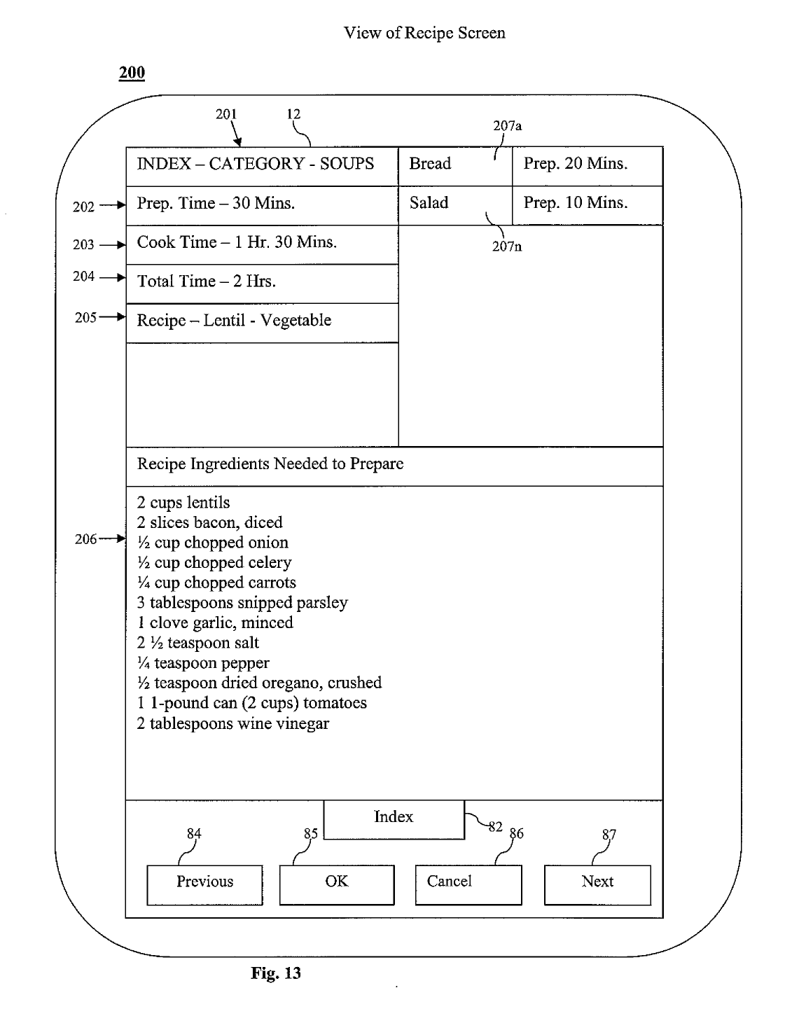

FIG. 13 is a schematic diagram of a recipe display screen 200. Selected food category types are displayed in portion 201. For each food category type, applicable preparation time is displayed in preparation portion 202, cook time is displayed in cook time portion 203 and total time is displayed in total time portion 204. The indexed title is displayed in title portion 205. Recipe ingredients are displayed in ingredients portion 206. Other selected food categories are shown in food category selection portions 207a-207n.

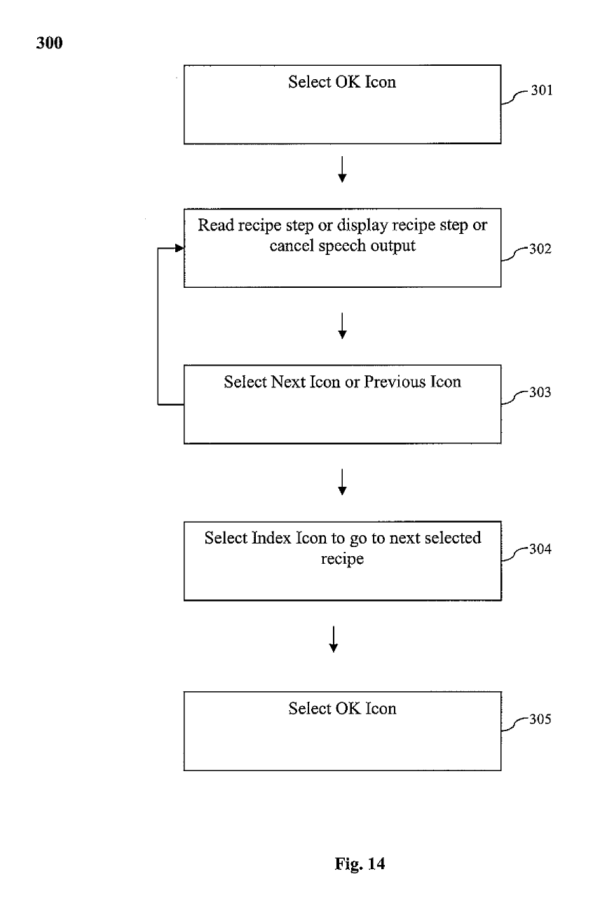

FIG. 14 is a flow diagram during an interactive displaying operation 300. After recipe display screen 200 is displayed, OK icon 85 can be selected in block 301 and a first step or line of the recipe is displayed. In block 302, the first step or line of the recipe will be read aloud as audio output from speaker 40 of electronic cookbook 10. The step or line of the recipe can include preparation and ingredient mixing instructions, conversion of measurements and possible ingredient substitutions. Alternatively, to display an individual step or line of the recipe without reading out loud, the speech can be turned off by selecting Cancel icon 86 and OK icon 85 at the same time and holding them for a predetermined amount of time, i.e., five seconds. After the predetermined time, electronic cookbook 10 can provide audio alert output, such as a beeping noise to alert a user that the speech output has been turned off. To restore, the speech output, Cancel icon 86 and OK icon 85 can be selected at the same time and held for a predetermined amount of time, i.e., five seconds. After the predetermined time, electronic cookbook 10 can provide audio alert output, such as a beeping noise to alert a user that the speech output has been turned on.

In block 303, Next icon 87 can be selected to return to block 302 and read or display the next step of the recipe or Previous icon 84 can be selected to repeat the step previously read or displayed by block 302. After the recipe is completed, Index icon 82 can be selected in block 304 to return to recipe display screen 200. OK icon 85 can be selected to bring up the next selected recipe from portion 207a-207n, in block 305. Each of the above-described icons is selected, for example, by clicking on or touching the icon. Alternatively, the icon can be selected by a user speaking a phrase such as “select” into microphone 42 and speech recognition device 68 converts the phrase into text which is processed by microprocessor 60 for making a selection.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. An electronic cookbook comprising:
a housing for housing a display screen;
means for mounting said housing in a kitchen environment;
means for indexing one or more electronic recipes from types of electronic recipes using a data processor;
means for displaying said one or more indexed electronic recipes on said display; and
means for selecting said one or more indexed electronic recipes; and
means for interactively displaying portions of said one or more selected recipes on said display using said data processor.

2. The electronic cookbook of claim 1 wherein said means for mounting said housing comprises:
a cabinet door hanger slidably extendable from a top of said housing, said cabinet door hanger including a pair of hanger rods each received in a channel formed in said housing, and a cabinet door hook mounted to a first end of each of said hanger rods,
wherein said cabinet door hook is adapted to be received over a kitchen cabinet door.

3. The electronic cookbook of claim 2 wherein said hanger rods are telescopic.

4. The electronic cookbook of claim 2 further comprising:
a roller attached to a second end of said hanger rod, said roller being attached to said hanger rod with a pin for providing lateral movement of said hanger rod within said channel.

5. The electronic cookbook of claim 2 wherein said cabinet door hook is mounted to said hanger rod with a pin for providing slight lateral movement of said hanger rod within said channel.

6. The electronic cookbook of claim 1 wherein said means for indexing one or more types of electronic recipes on said display comprises a main index screen including a plurality of food category icons and said food category icons can be selected.

7. The electronic cookbook of claim 1 wherein said indexed electronic recipes can be displayed in alphabetical order on said display.

8. The electronic cookbook of claim 1 wherein said means for displaying said one or more indexed electronic recipes on said display displays said one or more indexed electronic recipes in a longest to shortest preparation time format.

9. The electronic cookbook of claim 1 wherein said means for interactively displaying portions of said one or more selected recipes on said display reads each step or line of a recipe out loud and a next step icon can be selected for interactively displaying a next step or line of the electronic recipe.

10. The electronic cookbook of claim 1 wherein said means for interactively displaying portions of said one or more selected recipes on said display reads each step or line of a recipe out loud and a previous step icon can be selected for interactively displaying a previous step or line of the recipe.

11. The electronic cookbook of claim 1 wherein said means for interactively displaying portions of said one or more selected recipes on said display displays an individual step or line of a recipe on said display and a next step icon can be selected for interactively displaying a next step or line of the recipe.

12. The electronic cookbook of claim 1 wherein said means for interactively displaying portions of said one or more selected recipes on said display displays an individual step of a recipe on said display and next step icon can be selected for interactively displaying a next step of the recipe.

13. The electronic cookbook of claim 1 wherein said means for indexing said one or more types of electronic recipes on display includes a main index screen comprising a plurality of food category icons.

14. The electronic cookbook of claim 1 further comprising:
means for setting up said electronic cookbook for a particular language and/or measurement unit.

15. The electronic cookbook of claim 1 further comprising:
means for storing said electronic recipes at said data processor.

16. The electronic cookbook of claim 1 wherein said setting up said electronic cookbook for a particular language and/or measurement unit includes a setup screen comprising a plurality of language icons, a U.S. standard measure icon and an international metric measure icon.

17. The electronic cookbook of claim 1 further comprising a speech recognition device for translating speech spoken into a microphone into text.

18. The electronic cookbook of claim 1 further comprising a USB port for receiving a USB insertable memory stick including stored said one or more electronic recipes.

19. A method for managing and displaying an electronic cookbook comprising the steps of:
indexing one or more electronic recipes from types of electronic recipes using a data processor;
displaying said one or more indexed electronic recipes on said display;
selecting said one or more indexed electronic recipes; and
interactively displaying portions of said one or more selected recipes on said display using said data processor.

20. The method of claim 19 further comprising the step of:
mounting said display in a kitchen environment.

21. The method of claim 19 wherein said indexed electronic recipes can be displayed in alphabetical order on said display.

22. The method of claim 19 wherein said one or more indexed electronic recipes are displayed in a longest to shortest preparation time format.

23. The method of claim 19 wherein said step for interactively displaying portions of said one or more selected recipes on said display comprising reading each step or line of a recipe out loud and a next step icon can be selected for interactively displaying a next step or line of the electronic recipe and a previous step icon can be selected for interactively displaying a previous step or line of the recipe.

24. The method of claim 19 further comprising the step of setting up said electronic cookbook for a particular language and/or measurement unit including a setup screen comprising a plurality of language icons, a U.S. standard measure icon and an international metric measure icon.

25. The method of claim 19 further comprising the step of:
storing said electronic recipes at said data processor.

26. A program for managing and displaying an electronic cookbook, residing on a computer usable media having computer readable program code means, said program comprising:
means for indexing one or more electronic recipes from types of electronic recipes using a data processor;
means for displaying said one or more indexed electronic recipes on said display; and
means for selecting said one or more indexed electronic recipes; and
means for interactively displaying portions of said one or more selected recipes on said display using said data processor.
